(19) United States
(12) Patent Application Publication
(10) Pub. No.: US 2007/0028417 A1
(43) Pub. Date: Feb. 8, 2007

(54) Door stop for child safety

(76) Inventor: Daniel Lee Emmitt, Holly, MI (US)

Correspondence Address: BUTZEL LONG, STONERIDGE WEST, 41000 WOODWARD AVENUE, BLOOMFIELD HILLS, MI, 48304, US

(21) Appl. No.: 11/488,960

(22) Filed: Jul. 19, 2006

Related U.S. Application Data
(60) Provisional application No. 60/700,993, filed on Jul. 20, 2005.

(51) Int. Cl. E05F 5/02

(52) U.S. Cl. 16/82

(57) ABSTRACT

A door stop for releasable attachment to the edge of the door. The door stop prevents the door from being closed and hence prevents hands and fingers from being caught between the doorjamb and the door.

### TECHNICAL FIELD

The present invention relates generally to door stops. More particularly, the present invention relates to a door stop that may be removably attached to a door for the prevention of catching fingers between the door and the door jamb.

### BACKGROUND OF THE INVENTION

Given the opportunity, children, curious by nature, will venture throughout a house and other structure. Most homes today have swinging doors, although some have sliding “pocket” doors. In either case, children are known to have doors closed while their hands and fingers are still holding on to a doorjamb.

In order to keep a door open, door jambs are used today. To hold a door open, door stops known today comprise simple angular devices, typically made of a rubber or a plastic material. The door stops fit between the floor and the bottom of the door.

The problem with relying on door stops to keep doors from closing and to thus avoid getting little fingers caught between the door and the door jamb is that it is not practical to keep all doors of a house open at all times.

A satisfactory article for preventing little fingers from getting caught between a doorjamb and a door is wanting.

### SUMMARY OF THE INVENTION

The present invention provides a door stop that is releasably attachable to the edge of the door to prevent the door from being closed all of the way. According to the present invention, a door stop includes a transverse door slot that is formed either mid-way on the door stop or closer to one end or the other. The door stop is composed of a polymerized material that is elastic enough so that it may be releasably attached to the edge of the door. Once in place, the door cannot be closed, thus preventing children from having their fingers get caught between the door and the door jamb.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 shows a perspective view of a door stop according to the present invention;

FIG. 2 illustrates a side view of the door stop of the present invention showing the cut-away portion that attaches to the edge of a door;

FIG. 3 illustrates a top plan view of the door stop of the present invention showing the cut-away section;

FIG. 4 illustrates the door stop of the present invention in place on the edge of a partially open door; and

FIG. 5 illustrates an alternate embodiment of the present invention in which the transverse door slot is positioned at a place other than that shown in the embodiment of FIG. 2.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

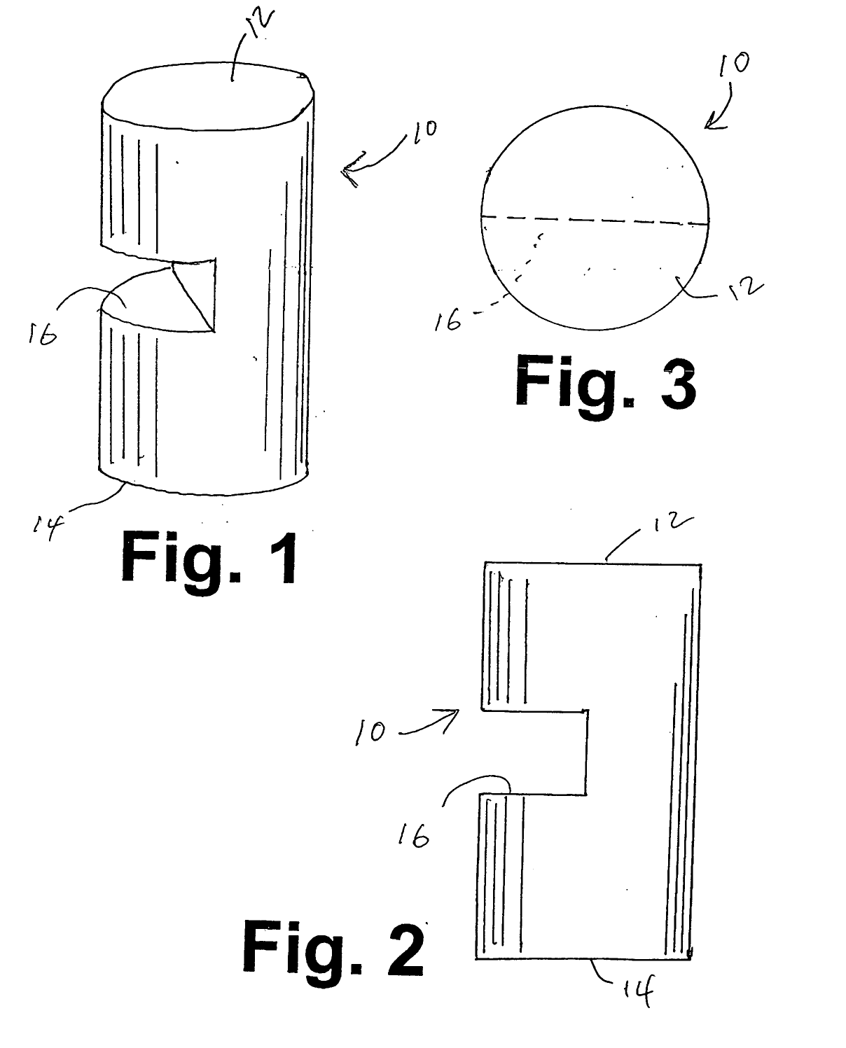

With reference to FIG. 1, a door stop, generally illustrated as 10, is shown in perspective view. The door stop 10 is preferably formed from a compressible material such as a foamed polymerized material such as a plastic or rubber. Alternative materials may be used, but it is desirable to compose the door stop 10 from a material that is at least slightly compressible so that it elastic enough to hold on to a door when in position thereupon.

The door stop 10 includes a first end 12, a second end 14, and a transverse door slot 16. The door stop 10 is illustrated as being cylindrical in configuration, but it must be understood that the shape of the door stop 10 may be altered to be square or elongated. The door stop 10 may be formed from an extruded material, cut to a desired length, and slotted as desired. Alternatively, the door stop 10 may be a molded article.

The transverse door slot 16 is configured so that it is slightly narrower than the width of a door. According to this configuration the door stop 10 may readily be attached to the door without falling off. However, it should not be so tight as to impede attachment and removal from the door.

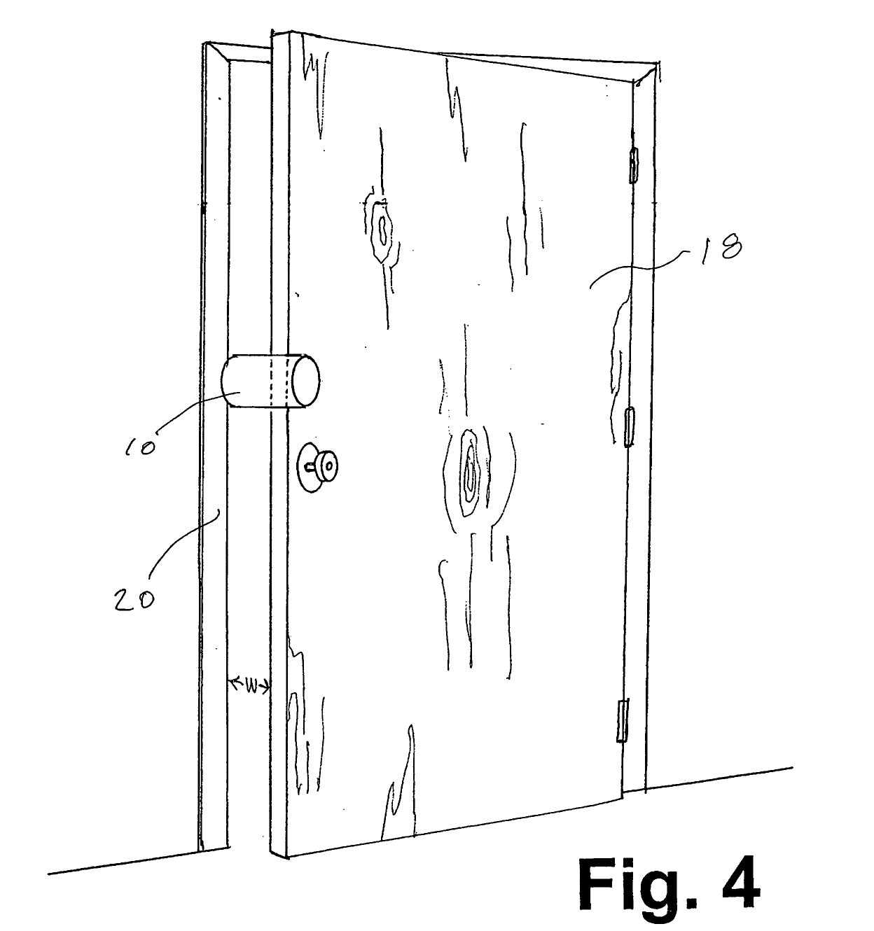

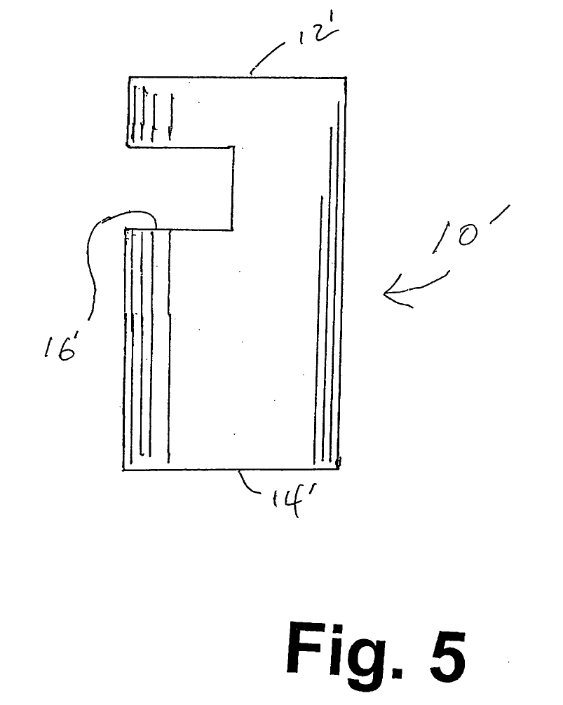

FIG. 4 illustrates a door 18 in position with respect to a door jamb 20. With the door stop 10 in place on the door 18, the door 18 is held open to a certain width “W” with respect to the door jamb 20. The door stop 10 is shown attached to an edge of the door 18. As illustrated in FIG. 1 and FIG. 2 the transverse door slot 16 is formed generally mid-way between the first end 12 and the second end 14 of the door stop 10. However, it may be that the transverse door slot 16 is formed closer to one end than the other so that the width “W” is made narrower or wider. This arrangement is illustrated in FIG. 5 where a door stop 10′ has a first end 12′ and a second end 14′. A transverse door slot 16′ is formed in the door stop 10′ at a point closer to the first end 12′ than the second end 14′. This arrangement allows for the same door stop to be used to define different widths “W” between the door and the door jamb.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A door stop for releasable attachment to the edge of a door, the door having a width, the door stop comprising:
a body having a first end, a second end, and a long axis defined between said first and second ends, said body having a slot formed therein transverse to said long axis of said body, said transverse slot being narrower than the width of the door.

2. The door stop of claim 1 wherein said transverse slot is formed approximately mid-way between said first end and said second end.

3. The door stop of claim 1 wherein said transverse slot is formed closer to one of said ends than the other.

4. The door stop of claim 1 wherein said body is formed from a polymerized material.

5. The door stop of claim 1 wherein said body is formed from a foamed plastic.

6. A method of keeping a door from closing against the door jamb, the door having an edge, the method comprising the steps of:
forming a door stop having a body, a first end, a second end opposite said first end, said body having a long axis defined between said first end and said second end, and a slot that is formed in said body transverse to said long axis; and
attaching said body to said door by fitting said transverse slot of said body onto the edge of the door.

7. The method of claim 6 wherein said transverse slot of said body is formed approximately mid-way between said first end and said second end.

8. The method of claim 7 wherein said transverse slot of said body is formed closer to said first end than said second end.

9. The method of claim 6 wherein said body is formed from a polymerized material.

10. The method of claim 6 wherein said body is formed from a foamed plastic.
